(19) United States
(12) Patent Application Publication
(10) Pub. No.: US 2012/0104961 A1
(43) Pub. Date: May 3, 2012

(54) LIGHTING DEVICE OF DISCHARGE LAMP AND METHOD OF CONTROLLING LIGHTING OF DISCHARGE LAMP

(75) Inventors: Kazuyuki IWAMOTO, Nagano (JP); Shunsuke KAMIMURA, Nagano (JP)

(73) Assignee: MINEBEA CO., LTD., Kitasaku-gun (JP)

(21) Appl. No.: 13/286,502

(22) Filed: Nov. 1, 2011

(30) Foreign Application Priority Data
Nov. 2, 2010 (JP) 2010-246425

(51) Int. Cl. H05B 41/26

(52) U.S. Cl. 315/224

(57) ABSTRACT

A lighting device of a discharge lamp, the lighting device includes: a DC voltage generating circuit including: a switching element that is controlled by a first controlling signal; and a coil that has one end portion, to which a first DC voltage is input, and the other end portion of the coil outputs a second DC voltage, and an AC voltage generating circuit that converts into an AC voltage and supplies to the discharge lamp; and a control circuit unit, which receives a polarity-inversion instructing signal, which generates a second controlling signal to determine a timing of polarity-inversion after a predetermined first period is elapsed, which sets a latest ON period, wherein the latest ON period is set based on both an elapsed time and the duty ratio, and which generates the first controlling signal to restart the ON/OFF control at a timing after a second period is elapsed.

### CROSS-REFERENCE TO RELATED APPLICATION

This application claims priority from Japanese Patent Application No. 2010-246425 filed on Nov. 2, 2010, the entire subject matter of which is incorporated herein by reference.

### BACK GROUND

The present disclosure relates to a lighting device of a discharge lamp driven by an alternating-current (AC) voltage, and a method of controlling lighting of a discharge lamp.

A lighting device of a discharge lamp, which is used in a light source for a front projector device or the like, includes a DC-DC converter circuit and a DC-AC inverter circuit. The DC-DC converter circuit converts a direct-current (DC) voltage supplied from the outside into a DC voltage which is appropriate for driving the discharge lamp, in order to perform constant current control or constant power control on a discharge lamp. The DC-AC inverter circuit converts the DC voltage generated by the DC-DC converter circuit into an AC voltage, and supplies the AC voltage as a driving voltage to the discharge lamp.

A method of driving the discharge lamp with the AC voltage suppress vaporized metals generated by heat during discharging from moving in only one direction between electrodes based on electrophoresis and applies load uniformly on the respective electrodes. Therefore, it is possible to suppress a specific electrode shape from changing and an increase in lifetime of the discharge lamp is thus expected.

In general, the lighting device of discharge lamp generates a high voltage by an igniter circuit or an LC resonant circuit so as to start the discharge lamp. While the polarity of the driving voltage of the discharge lamp is inverted, the DC-AC inverter circuit operating the discharge lamp with an AC, which includes an igniter transformer configuring the igniter circuit and inductance of a coil configuring the LC resonant circuit, is transitionally an unloaded state as seen from the DC-DC converter circuit side, so that the current does not flow mostly in the DC-AC inverter circuit. Also, while the polarity of the driving voltage of the discharge lamp is inverted, the current is commutated from the discharge lamp to the DC-DC converter circuit, according to the igniter transformer configuring the igniter circuit or the inductance component of the coil configuring the LC resonant circuit. Therefore, while the polarity of the driving voltage of the discharge lamp is inverted, an excessively large voltage is generated on a capacitor provided on the output side of the DC-DC converter circuit. After the polarity of the driving voltage is inverted, an overshoot or a ringing occurs in the current flowing in the discharge lamp.

As a result, a beat tone based on a change in magnetic flux is generated from the coil. Additionally, if the overshoot of the current or the ringing of the current, in which the discharge lamp is to be an over current state, are occurred at every time that the polarity of the driving voltage of the discharge lamp is inverted, the electrodes of the discharge lamp are damaged. Further, if the damage is accumulated, the lifetime of the discharge lamp is shortened.

Meanwhile, in a case where the polarity-inversion periods are different due to differences between phase angles of segments of a color wheel in a digital light processing (DLP) method or in a case where a plurality of discharge lamps are driven by using a discharge lamp lighting power in a liquid crystal method, and so on, it is required to control the polarity-inversion, synchronously.

In a case where the synchronization of a switching period of the DC-DC converter circuit and the polarity-inversion period is not controlled, a method, in which adjusting a target current value or of the DC-DC converter circuit or an ON period of a pulse width modulation (PWM) controlling signal to control a DC-DC converter circuit around a polarity-inversion timing, may suppress the overshoot or the ringing of the lamp current after the polarity-inversion. However, the rising waveform of the current flowing in the lamp cannot be uniformed at every polarity-inversion by those methods. FIG. 9 is a diagram illustrating the waveforms of voltages and currents of respective units according to the background art. As shown in FIG. 9, the lamp current changes in response to the relation between the PWM controlling signal and a polarity-inversion initiating signal for the driving voltage. As a result, an optical flicker of the discharge lamp is caused.

It is preferable to suppress the overshoot and the ringing, and JP-A-3-116693, JP-B-4350369, and WO-A-2009/008196 discloses methods to suppress the overshoot and the ringing.

### SUMMARY

However, in the method disclosed in JP-A-3-116693, a current supplied to a discharge lamp is inverted with gradually changing, so that the method is not appropriate for a recent lighting device of discharge lamp requiring a rapid polarity-inversion.

JP-B-4350369 is premised on a device for inversing a polarity of a DC-AC inverter circuit at a specific period. However, a driving voltage may not be inversed at the specific period in a DLP method projector or a control current may be different for every reversal of the polarity of the driving voltage, as to purposes of a discharge lamp. In this case, since a rising waveform of a current flowing in the discharge lamp cannot be uniformed at every polarity-inversion, the optical flicker of the discharge lamp will be occurred.

[JP0012]

WO-A-2009/008196, operation timings of the DC-DC converter circuit and the polarity-inversion timings of a DC-AC inverter circuit are synchronized with each other to suppress the overshoot and the ringing. However, for example, in a case where a polarity of a driving voltage in a DLP type projector is not inversed at the specific period or in a case where a plurality of discharge lamps are driven by using a discharge-lamp lighting power in a liquid crystal method, the polarity-inversion is controlled by an external synchronization signal, generally. Therefore, as to some purposes of the discharge lamp, the synchronization is difficult.

The present disclosure was made considering the above, and the present disclosure is to provide a lighting device of a discharge lamp and a method of controlling lighting of a discharge lamp to stably control a discharge lamp.

According to an illustrative aspect of the present disclosure, a lighting device of a discharge lamp includes: a DC voltage generating circuit; an AC voltage generating circuit; and a control circuit unit. The DC voltage generating circuit includes: a switching element that is controlled by a first controlling signal, which is pulse width modulated in a current continuity mode, so that the switching element is controlled in ON/OFF; and a coil that has one end portion, to which a first DC voltage is input through the switching element, and the other end portion of the coil, wherein other end portion of the coil outputs a second DC voltage, into which the first DC voltage is converted based on a duty ratio of the first controlling signal. The AC voltage generating circuit converts the second DC voltage into an AC voltage and supplies the AC voltage to the discharge lamp. The control circuit unit receives a polarity-inversion instructing signal that is asynchronous with the first controlling signal, generates a second controlling signal to determine a timing of polarity-inversion after a predetermined first period is elapsed with reference to a reception timing of the polarity-inversion instructing signal, sets a latest ON period of the switching element before the generation of the second controlling signal so that a current flowing in the coil when the polarity-inversion of the AC voltage starts is to be a first current value, wherein the latest ON period is set based on both an elapsed time from an ON timing of the switching element to the reception timing of the polarity-inversion instructing signal and the duty ratio of the first controlling signal in a normal state before the reception of the polarity-inversion instructing signal, and wherein the ON timing of the switching element is prior to or at the same time with the reception timing of the polarity-inversion instructing signal, and generates the first controlling signal to restart the ON/OFF control of the switching element at a timing after a second period, which is predetermined based on the current value flowing in the discharge lamp, is elapsed from the generation of the second controlling signal so that, when the ON/OFF control of the switching element restarts after the generation of the second controlling signal, a current flowing in the coil is to be a second current value.

According to an of the present disclosure, a method of controlling lighting of a discharge lamp uses a DC voltage generating circuit including: a switching element that is controlled by a first controlling signal, which is pulse width modulated in a current continuity mode, so that the switching element is controlled in ON/OFF; and a coil that has one end portion, to which a first DC voltage is input through the switching element, and the other end portion of the coil. The method comprising: outputting a second DC voltage, into which the first DC voltage is converted based on a duty ratio of the first controlling signal; converting the second DC voltage into an AC voltage and supplying the AC voltage to the discharge lamp; receiving a polarity-inversion instructing signal that is asynchronous with the first controlling signal; generating a second controlling signal to determine a timing of polarity-inversion after a predetermined first period is elapsed with reference to a reception timing of the polarity-inversion instructing signal; setting a latest ON period of the switching element before the generation of the second controlling signal so that a current flowing in the coil when the polarity-inversion of the AC voltage starts is to be a first current value, wherein the latest ON period is set based on both an elapsed time from an ON timing of the switching element to the reception timing of the polarity-inversion instructing signal and the duty ratio of the first controlling signal in a normal state before the reception of the polarity-inversion instructing signal, and wherein the ON timing of the switching element is prior to or at the same time with the reception timing of the polarity-inversion instructing signal; and generating the first controlling signal to restart the ON/OFF control of the switching element at a timing after a second period, which is predetermined based on the current value flowing in the discharge lamp, is elapsed from the generation of the second controlling signal so that, when the ON/OFF control of the switching element restarts after the generation of the second controlling signal, a current flowing in the coil is to be a second current value.

According to the above illustrative aspects of the present disclosure, even when the operation timing of the DC-DC converter circuit before the polarity-inversion and the polarity-inversion timing of the DC-AC inverter circuit are not synchronous, the latest ON period of the first controlling signal before the generation of the second controlling signal is set so that the current flowing in the coil of the DC-DC converter circuit is to be a intended value, and then the polarity of the driving voltage is inverted. Further, after the polarity-inversion, the switching operation of the DC-DC converter circuit may restarts with synchronizing the polarity-inversion, and it is possible to control the discharge lamp accurately and stably.

### BRIEF DESCRIPTION OF THE DRAWINGS

The foregoing and additional features and characteristics of this disclosure will become more apparent from the following detailed descriptions considered with the reference to the accompanying drawings, wherein:

FIG. 1 is a block diagram schematically illustrating a lighting device of a discharge lamp according to a first exemplary embodiment of the present disclosure;

FIG. 2 is a flow chart illustrating a process operation of a control circuit unit;

FIG. 3 is a diagram illustrating waveforms of voltages and currents of the respective units of the lighting device of FIG. 1;

FIG. 4 is a diagram illustrating examples of a change of a coil current when a polarity-inversion initiating signal is generated, with reference to a receiving timing of a polarity-inversion instructing signal;

FIG. 5 is a diagram obtained by superimposing a plurality of different relations between a receiving timing of polarity-inversion instructing signals, and the coil current when the generation of the polarity-inversion initiating signal, with reference to the waveform of the coil current;

FIG. 6 is a flow chart illustrating a process operation of a control circuit unit;

FIG. 7 is a diagram illustrating the waveforms of voltages and currents of the respective units of the lighting device of FIG. 1;

FIG. 8 is a block diagram schematically illustrating a lighting device of a discharge lamp according to a modification of FIG. 1; and

FIG. 9 is a diagram illustrating the waveforms of voltages and currents of respective units according to the background art.

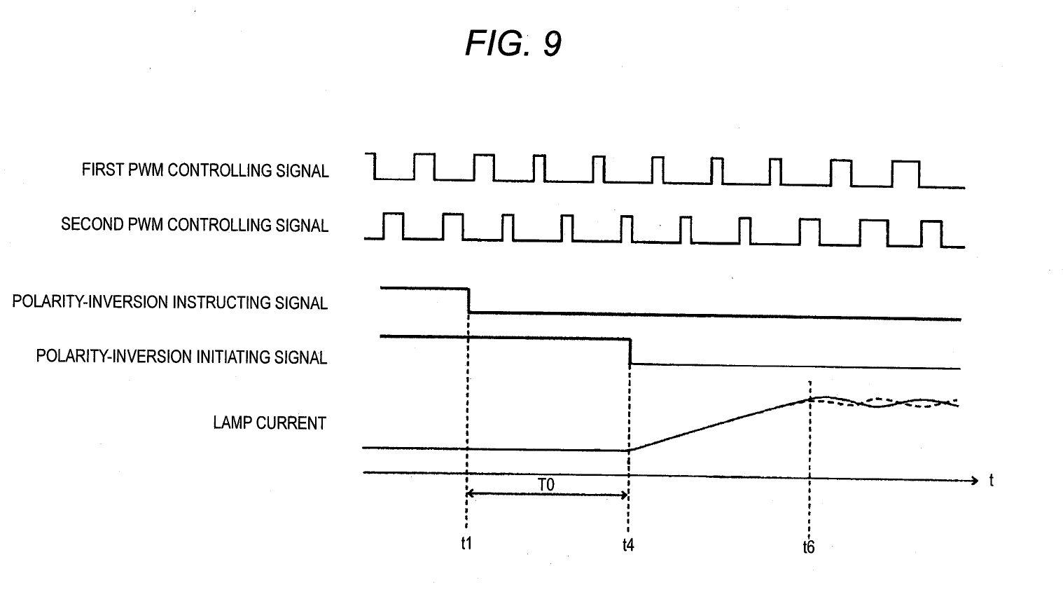

### DETAILED DESCRIPTION

Hereinafter, a lighting device of a discharge lamp and a method of controlling lighting of a discharge lamp according to exemplary embodiments of the present disclosure will be described in detail with reference to the accompanying drawings.

### First Exemplary Embodiment

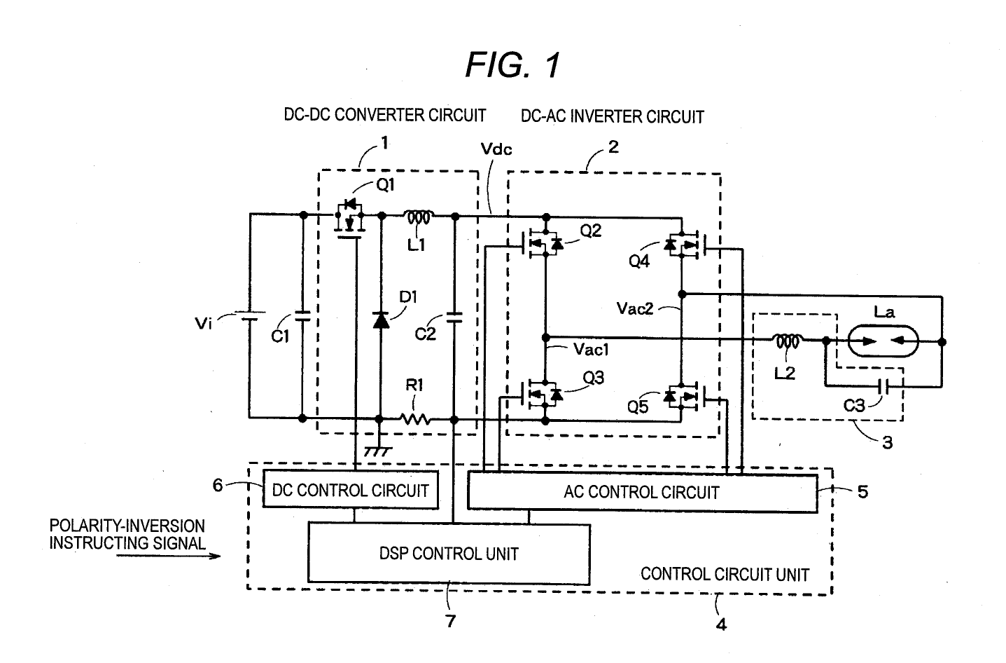

FIG. 1 is a block diagram schematically illustrating a lighting device of a discharge lamp La (hereinafter, referred to as a lighting device) according to a first exemplary embodiment of the present disclosure. The lighting device of FIG. 1 includes a DC-DC converter circuit (DC voltage generating circuit) 1, a DC-AC inverter circuit (AC voltage generating circuit) 2, a resonant circuit 3, and a control circuit unit 4.

The DC-DC converter circuit 1 includes a switching element Q1, a diode D1, a coil L1, a capacitor C2, and a resistor R1. The switching element Q1, the coil L1, the capacitor C2, and the resistor R1 are connected in cascade between a power supply terminal and a ground terminal. The diode D1 has an anode connected to the ground terminal and a cathode connected to a connection node of the coil L1 and the switching element Q1. The switching element Q1 is, for example, an n-type Metal Oxide Semiconductor Field Effect Transistor (nMOSFET).

A power supply voltage (first DC voltage) Vi is supplied from a power factor correction (PFC) power supply circuit to the power supply terminal, for example. The power supply voltage V1 is, for example, about 380 V. Further, a capacitor C1 may be provided between the power supply terminal and the ground terminal to reduce noise of the power supply voltage V1 and to supply the power supply voltage V1 to the DC-DC converter circuit 1. The switching element Q1 is controlled by a pulse width modulated controlling signal (hereinafter, referred to as a PWM signal or a first controlling signal) supplied from the control circuit unit 4, so that the switching element Q1 is switched on or off.

When the switching element Q1 is switched on to be conducted, the power supply voltage V1 is input to one end portion of the coil L1 through the switching element Q1, and the capacitor C2 connected to the other end portion of the coil L1 is to be charged. When a current is supplied to the DC-AC inverter circuit 2, the capacitor C2 is discharged. While the switching element Q1 is in an ON state, a current flowing in the coil L1 increases, and the increased amount is charged in the capacitor C2. When the capacitor C2 is charged, the current to be supplied to the DC-AC inverter circuit 2 increases, and a DC voltage Vdc to be output the other end portion of the coil L1 also increases. In this case, the cathode of the diode D1 has a high voltage and is not conductive.

Meanwhile, if the switching element Q1 is switched off and break the power supply voltage V1, in order to suppress the change of the current of the coil L1, the voltage of the cathode of the diode D1 decreases, and the capacitor C2 is charged from the diode D1 through the coil L1. Therefore, the current is supplied to the DC-AC inverter circuit 2. While the switching element Q1 is in an OFF state, the current flowing in the coil L1 decreases, and the decreased current is compensated by the capacitor C2. If the capacitor C2 is discharged, the current supplied to the DC-AC inverter circuit 2 decreases, and the DC voltage Vdc output by the DC-DC converter circuit 1 also decreases.

In the above-mentioned manner, the DC-DC converter circuit 1 converts the power supply voltage V1 into the DC voltage (second DC voltage) Vdc according to a duty ratio of the PWM controlling signal. The duty ratio of the PWM controlling signal may be feedback-controlled to perform constant current control on the discharge lamp La, as will be described below.

The DC-AC inverter circuit 2 has switching elements Q2 to Q5. The switching elements Q2 and Q3 are connected in cascade between an output terminal of the DC-DC converter circuit 1 and the ground terminal, and an AC voltage Vac1 is output from a connection node of the switching elements Q2 and Q3. Similarly, the switching elements Q4 and Q5 are connected in cascade between an output terminal of the DC-DC converter circuit 1 and the ground terminal, and an AC voltage Vac2 is output from a connection node of the switching elements Q4 and Q5. The switching elements Q2 to Q5 are, for example, nMOSFETs.

The switching elements Q2 to Q5 are controlled by an inversion controlling signal supplied from the control circuit unit 4, and the switching elements Q2 to Q5 are switched on or off. If the switching elements Q2 and Q5 are switched on and the switching elements Q3 and Q4 are switched off, the AC voltage Vac1 is to be equal to the DC voltage Vdc, and the AC voltage Vac2 is to be 0 V. Meanwhile, if the switching elements Q3 and Q4 are switched on and the switching elements Q2 and Q5 are switched off, the AC voltage Vac1 is to be 0 V, and the AC voltage Vac2 is to be equal to the DC voltage Vdc. An AC voltage Vac2-Vac1 is supplied as a driving voltage to the discharge lamp La through the resonant circuit 3.

Immediately after the discharge lamp La is lighted, the amplitude of the driving voltage is, for example, about 20 V. In a normal state, the amplitude of the driving voltage is, for example, about 50 V to 160 V. The polarity of the driving voltage is inverted at a frequency about 50 Hz to 500 Hz, for example. As described above, the DC-AC inverter circuit 2 supplies the AC voltage to the discharge lamp La, so that a load is uniformly applied to each electrode of the discharge lamp La. Therefore, it is possible to increase the lifetime of the discharge lamp La.

The resonant circuit 3 includes a coil L2 and a capacitor C3, which are connected in series between the connection node of the switching elements Q2 and Q3 and the connection node of the switching elements Q4 and Q5. The resonant circuit 3 generates a voltage higher than an output voltage of the DC-AC inverter circuit 2 by third order resonance or fifth order resonance, thereby lighting light the discharge lamp La.

The control circuit unit 4 includes an AC control circuit 5, a DC control circuit 6, and a digital signal processor (DSP) control unit 7.

The AC control circuit 5 generates the inversion controlling signal and supplies to the switching elements Q2 to Q5 of the DC-AC inverter circuit 2, so that the switching elements Q2 to Q5 are controlled to be switched on or off. If the DSP control unit 7 detects a polarity-inversion instructing signal and then a period T0, which is according to the specifications of the discharge lamp La and so on, is elapsed, the DSP control unit 7 generates a polarity-inversion initiating signal (second controlling signal) and supplies the polarity-inversion initiating signal to the AC control circuit 5. The AC control circuit 5 generates the inversion controlling signal with synchronizing with the polarity-inversion initiating signal, so that the polarity-inversion timing of the driving voltage is controlled.

Here, the polarity-inversion instructing signal is a signal to instruct the inversion of polarity of the driving voltage. Generally, when a plurality of discharge lamps La are respectively controlled by a plurality of lighting devices, in order to synchronize timings of polarity-inversion, the polarity-inversion instructing signal is input from the outside. Obviously, in a case where single discharge lamp La is controlled, the polarity-inversion instructing signal may be generated in the control circuit unit 4.

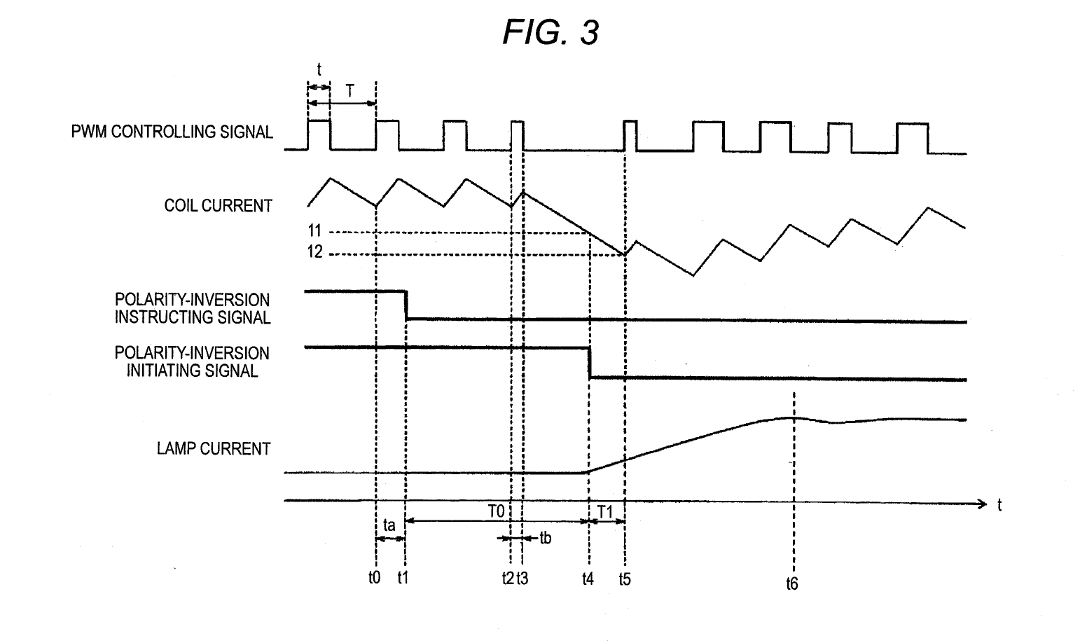

The DC control circuit 6 generates the PWM controlling signal and supplies the PWM controlling signal to the switching element Q1 of the DC-DC converter circuit 1, so that the switching element Q1 is controlled to be switched ON/OFF. The DSP control unit 7 controls the DC control circuit 6. Specifically, the DSP control unit 7 detects the voltage of the resistor R1, which is proportional to the current flowing in the discharge lamp La (hereinafter, referred to as a lamp current), and feedback-controls the duty ratio of the PWM controlling signal, which is generated by the DC control circuit 6 so that the lamp current is to be constant except for the vicinity of a period in which the polarity of the driving voltage is inverted (a period between a time t4 and a time t6 in FIG. 3). In periods except for the period in which the polarity of the driving voltage is inverted (the period between a time t4 and a time t6 in FIG. 3), the control of the discharge lamp La may be either a voltage mode control type as described above or a peak current mode control type to feedback-control a threshold of the lamp current.

In a case where the polarity-inversion instructing signal and the PWM controlling signal are asynchronous, the control circuit unit 4 generates the PWM controlling signal so that the current flowing in the coil L1 is to be a intended current value I1 (first current value). Therefore, it is possible to suppress the overshoot and the ringing of the lamp current. Further, the control circuit unit 4 generates the PWM controlling signal so that the switching element Q1 is switched on again at a timing at which a second period, which is predetermined based on the current value flowing in the discharge lamp, is elapsed after the polarity-inversion initiating signal is generated. Therefore, it is possible to uniform the rising waveform of the lamp current at every polarity-inversion and the optical flicker is thus suppressed.

Even in the case where the polarity-inversion instructing signal and the PWM controlling signal are asynchronous, the first exemplary embodiment can control the discharge lamp La stably.

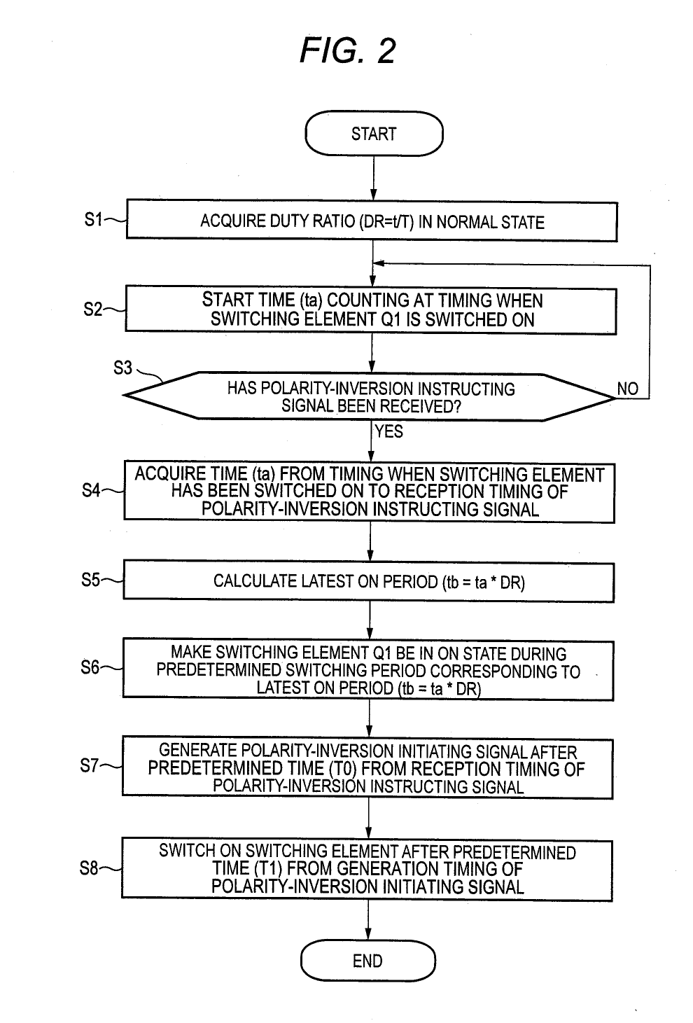

FIG. 2 is a flow chart illustrating a process operation of a control circuit unit 4. Further, FIG. 3 is a diagram illustrating waveforms of voltages and currents of the respective units of the lighting device of FIG. 1. In FIG. 3, time is indicated in the horizontal axis, and the PWM controlling signal, the current flowing in the coil L1 (hereinafter, referred to as coil current), the polarity-inversion instructing signal, the polarity-inversion initiating signal, and the lamp current are sequentially indicated in the vertical axis. In FIG. 3, an example in which the switching element Q1 is an nMOSFET is shown. Further, it is assumed that the present exemplary embodiment is in a current continuity mode, in which the current continuously flows in the coil L1 in not only a period in which the switching element Q1 is in the ON state but also a period in which the switching element Q1 is in the OFF state in the normal state.

First, in step S1, the DSP control unit 7 acquires the duty ratio DR of the PWM controlling signal in the normal sate. The duty ratio is represented by a ratio t/T, in which a one period of the PWM controlling signal is T and a time period while the PWM controlling signal is being high level is t, as shown in FIG. 3. Since the variation of the duty ratio is not much in the normal state, the DSP control unit 7 may acquire a duty ratio DR at a last time or an average duty ratio DR of a predetermined period. The acquired duty ratio DR may be updated at every the polarity-inversion of the driving voltage or may be updated at the specific period.

A period, in which the change of the duty ratio DR is not so much before the polarity-inversion instructing signal is received (before a time t0 in FIG. 3), is called as the normal state.

Next, in step S2, the DSP control unit 7 starts counting of a time, which is to be regarded as a elapsed time ta, at a timing at which the switching element Q1 is switched on (that is, a rising timing of the PWM controlling signal). Sequentially, in step S3, the DSP control unit 7 waits for inputting of the polarity-inversion instructing signal. In step S4, if the polarity-inversion instructing signal is inputted at a time t1 of FIG. 3, the DSP control unit 7 acquires a final counted value of the elapsed time ta (t1-t0 in FIG. 3) from the rising timing of the PWM controlling signal to the reception timing of the polarity-inversion instructing signal, and then the counting is stopped. The DSP control unit 7 counts the time counting with reference to the rising timing of the PWM controlling signal. If the polarity-inversion instructing signal is not received in one period of the PWM controlling signal, the DSP control unit 7 resets the count value at the next rising timing of the PWM controlling signal and performs counting again.

That is, the elapsed time ta is from the timing, at which the switching element Q1 is switched on before or at the same time the reception timing of the polarity-inversion instructing signal, to the reception timing the polarity-inversion instructing signal.

If receiving the polarity-inversion instructing signal, the DSP control unit 7 generates the polarity-inversion initiating signal after a predetermined period (first period) T0 is elapsed. On the other hand, prior to the generation of the polarity-inversion initiating signal, the DSP control unit 7 calculates a period tb, in which the PWM controlling signal is at the high level (hereinafter, referred to a latest ON period), as tb=ta*DR in step S5, and the switching element Q1 is controlled be in the ON state during a predetermined switching period corresponding to the latest ON period tb in step S6. Specifically, the PWM controlling signal rises at a time t2 of FIG. 3, and after the latest ON period tb is elapsed, the PWM controlling signal falls at a time t3. The DSP control unit 7 may read the latest ON period from a prepared conversion table based on the elapsed time ta and the duty ratio DR.

Then, the PWM controlling signal controls the switching element Q1 not to be the ON state until step S8 (to be described below), so that the operation of the DC-DC converter circuit 1 is stopped. During that period, the coil current gradually decreases. In step S7, at a time t4, the DSP control unit 7 generates the polarity-inversion initiating signal after the period T0 is elapsed from the time t1, at which the polarity-inversion instructing signal is received. With synchronizing the polarity-inversion initiating signal, the AC control circuit 5 of FIG. 1 controls the switching elements Q2 to Q5 so that the polarity of the driving voltage is inverted.

Since the latest ON period is set as described above, it is possible to control the coil current to be the intended current value I1 at the time, at which the polarity-inversion initiating signal is generated, regardless of the reception timing of the polarity-inversion instructing signal. This will be described in more detail.

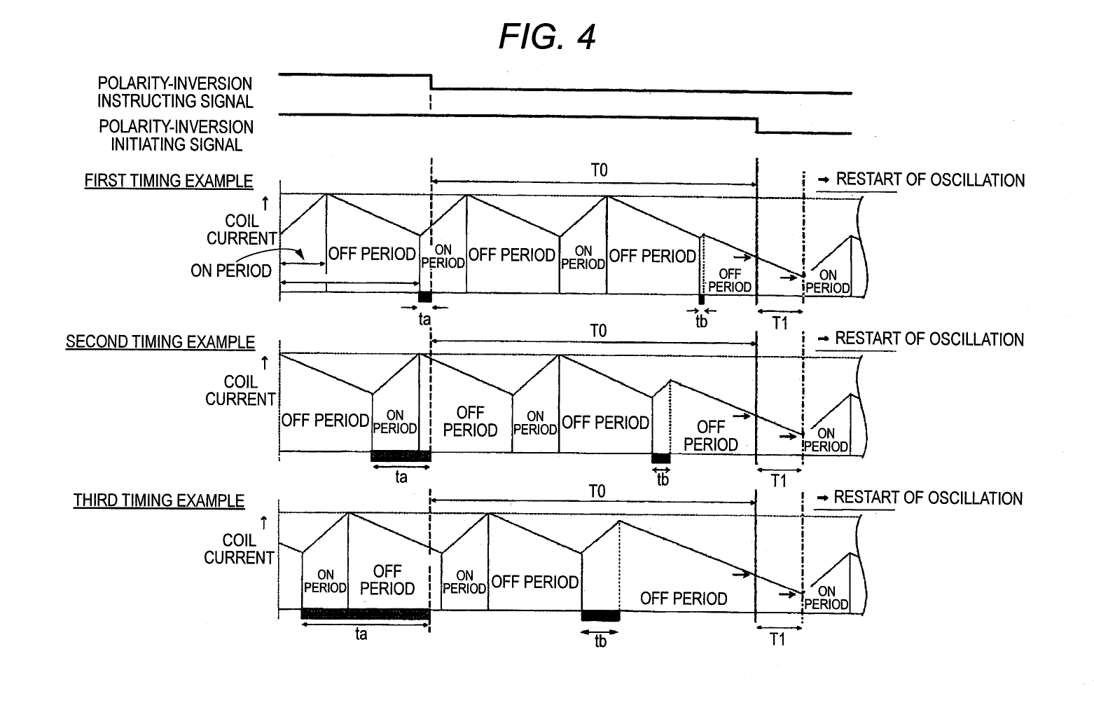

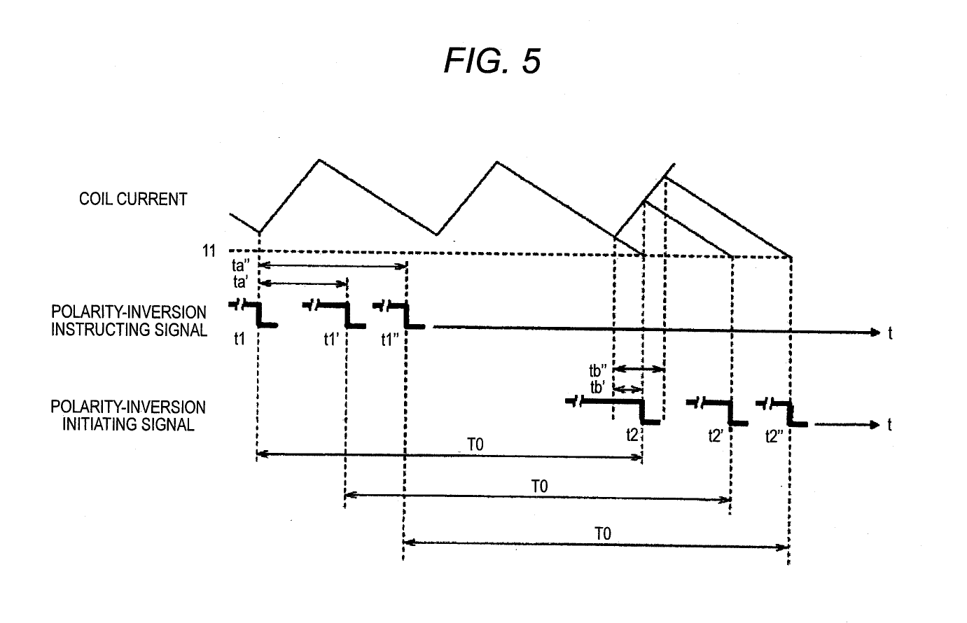

FIG. 4 is a diagram illustrating examples of the changing-process of the coil current from the reception timing of the polarity-inversion instructing signal to the generation timing of the polarity-inversion initiating signal. FIG. 5 is a diagram obtained by superimposing a plurality of different relations between receiving timing of polarity-inversion instructing signals, and the coil current when the generation of the polarity-inversion initiating signal, with reference to the waveform of the coil current. The period between the reception of the polarity-inversion instructing signal and the generation of the polarity-inversion initiating signal is constant (the period T0), and each of an inclination of the coil current during increasing and an inclination of the coil current during decreasing is also constant. For this reason, the latest ON period tb is set as tb=ta*DR. Therefore, even when the reception period of the polarity-inversion instructing signal is any one of t1, t1′, and t1″ shown in FIG. 5, the current value I1 is constant at the generation period t2, t2′, or t2″ of the polarity-inversion initiating signal corresponding to the reception period of the polarity-inversion instructing signal.

The period T0 of FIG. 3 is a specific value according to the specifications of the lighting device or the discharge lamp La, or the like. For example, the more the inductance value of the coil L1 increases, the more it is decreases that the inclination of decreasing of the coil current after the operation of the DC-DC converter circuit 1 stops. Therefore, in order to make the current value I1 sufficiently small, the period T0 may be set according to the inductance value.

In FIG. 3, the period T0 is set to correspond to about three periods of the PWM controlling signal, and a pulse width of the PWM controlling signal after two periods from the reception of the polarity-inversion instructing signal is set as the latest ON period. However, in a case so that it is possible to calculate the latest ON period in a short time, the period T0 may be set to be short, and a pulse width of an immediate PWM controlling signal after the reception of the polarity-inversion instructing signal may be set as the latest ON period. Further, it may be determined that the latest ON period tb is to be set a period, in which the switching element Q1 is in the ON state in the period T0, that is, in which the PWM controlling signal is at the high level, based on at least one of the inductance value of the coil L1 and a period where the switching element Q1 is controlled so that the switching element Q1 is switched on or off.

In this manner, the coil current when polarity-inversion of the driving voltage start is to be the intended current value I1, regardless of the reception timing of the polarity-inversion instructing signal. Therefore, energy charged in the capacitor C2 is suppressed. As a result, even in the unloaded state of the DC-DC converter circuit 1 while the polarity of the driving voltage is being inverted, the voltage between both end portions of the capacitor C2, that is, the DC voltage Vdc is suppressed from rising extremely. Therefore, it is possible to suppress the overshoot and the ringing.

Referring to FIGS. 2 and 3, the DSP control unit 7 restarts the operation of the DC-DC converter circuit 1 with synchronizing the polarity-inversion initiating signal. Specifically, when the DSP control unit 7 has generated the polarity-inversion initiating signal at the time t4 and a predetermined period (second period) T1 is elapsed from the time t4, the DSP control unit 7 controls the DC control circuit 6 so that the DC control circuit 6 sets the PWM controlling signal at the high level at a time t5. In this manner, in step S8, the switching element Q1 is switched on at the time t5.

Since the coil current when the generation of the polarity-inversion initiating signal is to be the intended current value I1 regardless of the reception timing of the polarity-inversion instructing signal, even when the switching element Q1 is switched on so that the operation of the DC-DC converter circuit 1 restarts, the coil current is to be a intended current value I2. As a result, the waveform of the lamp current is uniformed at every polarity-inversion of the driving voltage. Therefore, it is possible to suppress the optical flicker of the discharge lamp La.

As described above, in the first exemplary embodiment, in the case where the polarity-inversion instructing signal and the PWM controlling signal are asynchronous, the current flowing in the coil L1 at the timing, at which polarity-inversion of the driving voltage starts, can be set to the intended current value I1, regardless of the reception timing of the polarity-inversion instructing signal. Therefore, it is possible to suppress the overshoot and ringing of the lamp current. Further, since the operation of the DC-DC converter circuit 1 restarts at a intended timing with synchronizing the polarity-inversion initiating signal, the lamp current becomes the intended current value I2 at the time at which the operation of the DC-DC converter circuit 1 restarts. Therefore, it is possible to uniform the waveform of the lamp current at every polarity-inversion of the driving voltage and to suppress the optical flicker of the discharge lamp La. Additionally, even when the polarity-inversion instructing signal and the PWM controlling signal are synchronous, those effects are achieved.

### Second Exemplary Embodiment

In the above-mentioned first exemplary embodiment, the current values I1 and I2 are determined based on the elapsed time ta and the duty ratio of the PWM controlling signal. However, in a second exemplary embodiment to be described below, fine adjustment of the current values I1 and I2 may be possible.

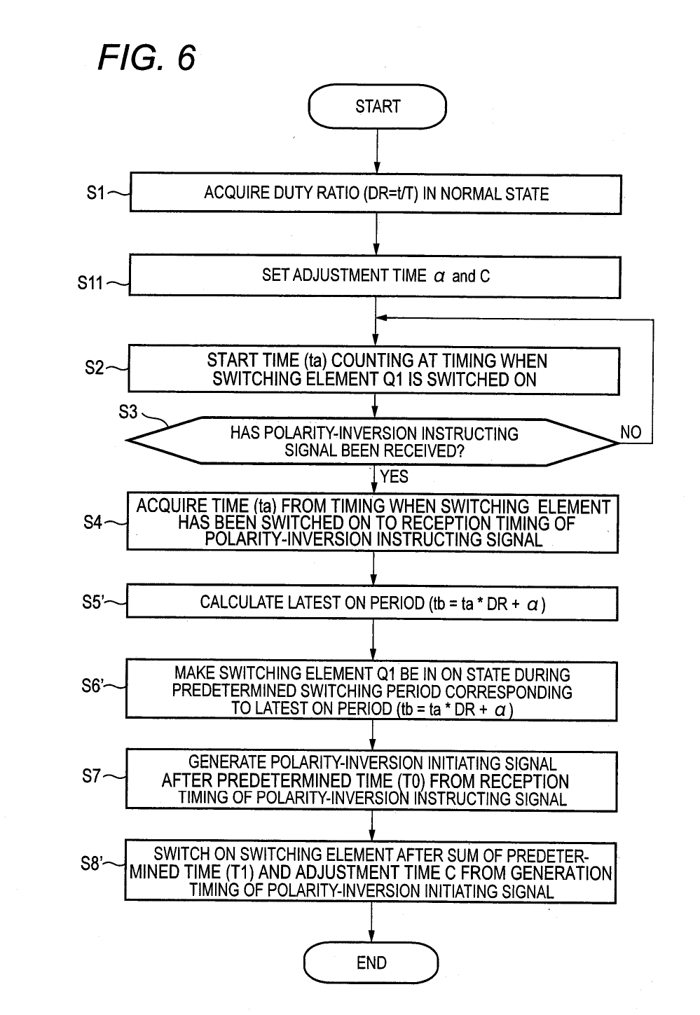

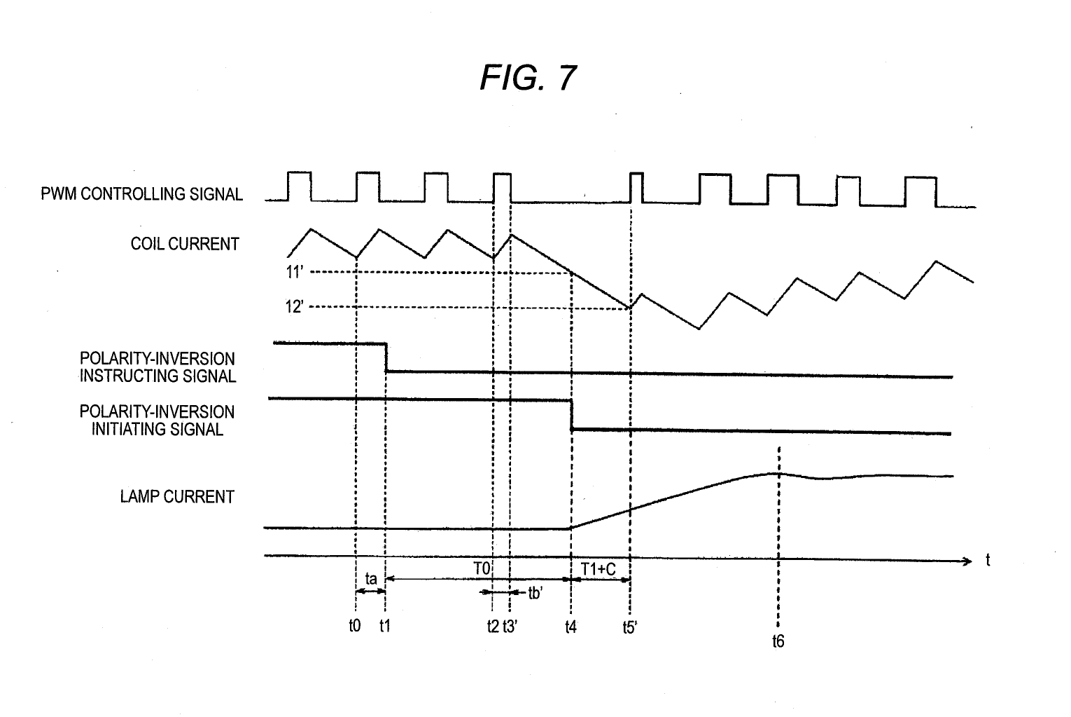

A process operation of a control circuit unit 4a of the second exemplary embodiment is different from that of the control circuit unit 4 of the first exemplary embodiment. FIG. 6 is a flow chart illustrating a process operation of a control circuit unit 4a. Further, FIG. 7 is a diagram illustrating the waveforms of voltages and currents of the respective units of the lighting device of FIG. 1, and the horizontal axis and the vertical axis of FIG. 7 are the same as those of FIG. 3. The second exemplary embodiment will be described with focusing on differences from the first exemplary embodiment.

After acquiring the duty ratio DR of the PWM controlling signal in step S1, in step S11, the DSP control unit 7 sets adjustment time α and C based on the lamp current. The lamp current may be calculated from a voltage between both end portions of the resistor R1 or may be estimated from the duty ratio DR and the power supply voltage Vi. A relation between the lamp current and the adjustment time α and C will be described below.

[JP0053]

Next, after steps S2, S3, AND S4 same as those of FIG. 2, the DSP control unit 7 calculates the latest ON period tb′ of the PWM controlling signal as tb′=ta*DR+α in step S5′, and the DSP control unit 7 controls the switching element Q1 to be the ON state during a predetermined switching period corresponding to the latest ON period tb′ in step S6′. Specifically, the PWM controlling signal rises at a time t2 of FIG. 7, and the PWM controlling signal falls at a time t3′ after the latest ON period tb′ is elapsed.

Then, in step S7, at a time t4 after the period T0 is elapsed from the time t1, at which the polarity-inversion instructing signal is received, the DSP control unit 7 generates the polarity-inversion initiating signal. Since the latest ON period tb′ is longer than the latest ON period tb of FIG. 3 by the adjustment time α, a current value I1′ of the coil L1 during the generation of the polarity-inversion initiating signal is larger than the current value I1 of FIG. 3. As the adjustment time a increases, the current value I1′ increases.

Then, the DSP control unit 7 restarts the operation of the DC-DC converter circuit 1 with synchronizing the polarity-inversion initiating signal. Specifically, the DSP control unit 7 generates the polarity-inversion initiating signal at the time t4, and, the DSP control unit 7 controls the DC control circuit 6 so that the DC control circuit 6 sets the PWM controlling signal at the high level at a time t5 after a period (T1+C) (in which C may be negative) is elapsed. In this manner, in step S8′, the switching element Q1 is switched on at the time t5′. As the adjustment time C increases, a current value I2′ when the switching element Q1 is switched on decreases.

As described above, the second exemplary embodiment is different from the first exemplary embodiment shown in FIG. 3 in that the latest ON period tb' of the PWM controlling signal is represented as tb′=ta*DR+α, and that the timing, at which the switching element Q1 is switched on, is after the period (T1+C) is elapsed from the generation of the polarity-inversion initiating signal.

Accordingly, the current values I1′ and I2′ can be adjusted by the adjustment time α and C in the second exemplary embodiment. In response to the adjustment time α and C, the current values I1′ and I2′ can be set so that the overshoot and the ringing are suppressed.

For example, in a case where the lamp current is large, the adjustment time α is set to be small. As a result, since the current value I1′ of the coil current when the generation of the polarity-inversion instructing signal is to be small, it is possible to suppress the overshoot and the ringing of the lamp current. However, if the adjustment time α is excessively small, the rising of the coil current is slow, and thus the polarity-inversion requires a long time. If the adjustment time C is set to be large, the rising of the coil current is to be slow, so that the restart timing of the operation of the DC-DC converter circuit 1 is delayed. As a result, it takes the coil current a long time to converge.

With considering those points, an optimal adjustment time α and C are calculated according to the lamp current or are read from a conversion table prepared. The adjustment time α and C may be updated at every polarity-inversion of the driving voltage or may be updated at the specific period of several ms, for example. Alternatively, either one of the adjustment times a or C may be set.

As described above, in the second exemplary embodiment, the current value I1′ at stating of polarity-inversion and the current value I2′ at restarting of the operation of the DC-DC converter circuit 1 are finely adjusted by the adjustment time α and C. Therefore, it is possible to suppress the discharge lamp La more stably.

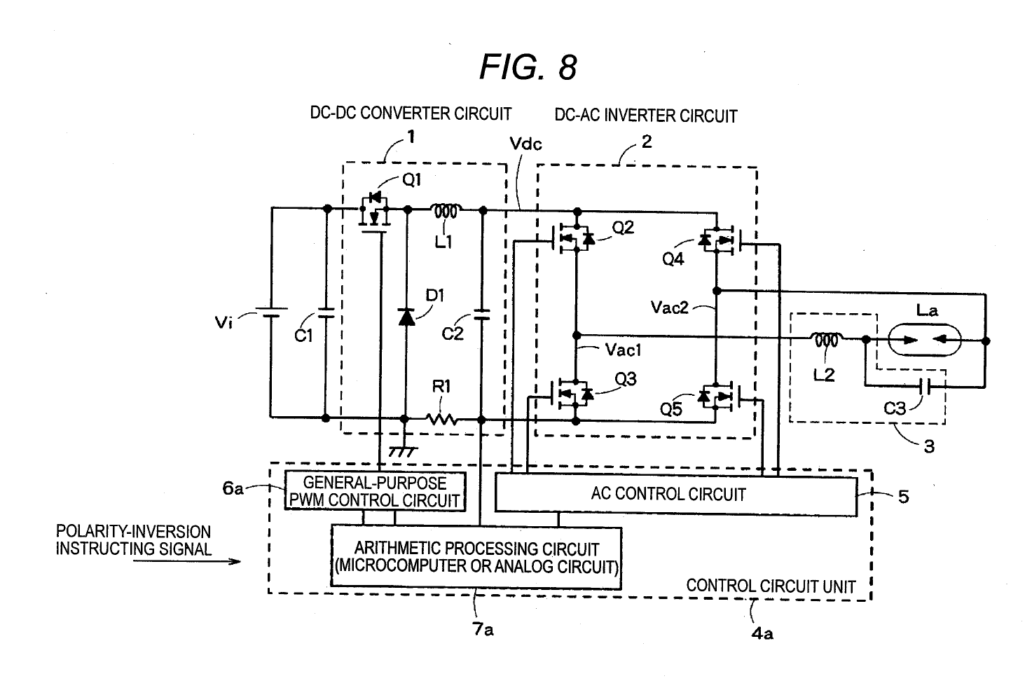

FIG. 8 is a block diagram schematically illustrating a lighting device of a discharge lamp La according to a modification of FIG. 1. An internal configuration of a control circuit unit 4a is different from the control circuit unit 4 of FIG. 1. The control circuit unit 4a includes a general-purpose PWM control circuit 6a instead of the DC control circuit 6, an AC control circuit 5, and an arithmetic processing circuit 7a instead of the DSP control unit 7. The arithmetic processing circuit 7a may be configured by a microcomputer or an analog circuit and may perform the process operation of FIG. 2 or 6.

According to the present disclosure, skilled persons in the art may consider additional effects and various modifications. However, the illustrative aspects of the present disclosure are not limited to the above-mentioned respective exemplary embodiments. Various additions, changes, and partial elimination are possible without departing from the conceptual scope and purpose of the present disclosure.

What is claimed is:

1. A lighting device of a discharge lamp, the lighting device comprising:
a DC voltage generating circuit including:
a switching element that is controlled by a first controlling signal, which is pulse width modulated in a current continuity mode, so that the switching element is controlled in ON/OFF; and
a coil that has one end portion, to which a first DC voltage is input through the switching element, and the other end portion of the coil, wherein other end portion of the coil outputs a second DC voltage, into which the first DC voltage is converted based on a duty ratio of the first controlling signal; and
an AC voltage generating circuit that converts the second DC voltage into an AC voltage and supplies the AC voltage to the discharge lamp; and
a control circuit unit,
which receives a polarity-inversion instructing signal that is asynchronous with the first controlling signal,
which generates a second controlling signal to determine a timing of polarity-inversion after a predetermined first period is elapsed with reference to a reception timing of the polarity-inversion instructing signal,
which sets a latest ON period of the switching element before the generation of the second controlling signal so that a current flowing in the coil when the polarity-inversion of the AC voltage starts is to be a first current value, wherein the latest ON period is set based on both an elapsed time from an ON timing of the switching element to the reception timing of the polarity-inversion instructing signal and the duty ratio of the first controlling signal in a normal state before the reception of the polarity-inversion instructing signal, and wherein the ON timing of the switching element is prior to or at the same time with the reception timing of the polarity-inversion instructing signal, and
which generates the first controlling signal to restart the ON/OFF control of the switching element at a timing after a second period, which is predetermined based on the current value flowing in the discharge lamp, is elapsed from the generation of the second controlling signal so that, when the ON/OFF control of the switching element restarts after the generation of the second controlling signal, a current flowing in the coil is to be a second current value.

2. The lighting device of discharge lamp according to claim 1,
wherein the control circuit unit determines whether any one of the ON timings of the switching element in the first period is to be set as a latest ON timing, based on at least one of an inductance value of the coil and a period of the ON/OFF control of the switching element.

3. The lighting device of discharge lamp according to claim 1,
wherein the control circuit unit sets the latest ON period based on multiplying the elapsed time by the duty ratio in the normal state.

4. The lighting device of discharge lamp according to claim 1,
wherein the control circuit unit sets a time derived from a conversion table prepared in advance as the latest ON period of the switching element before the generation of the second controlling signal, based on both the elapsed time and either a relation between the first DC voltage and the second DC voltage or the duty ratio in the normal state.

5. The lighting device of discharge lamp according to claim 1,
wherein the control circuit unit sets the latest ON period based on a value obtained by adding a result of multiplying the elapsed time by the duty ratio in the normal state and to a first adjustment time determined based on the current flowing in the discharge lamp.

6. The lighting device of discharge lamp according to claim 5,
wherein the control circuit unit uses the first adjustment time based on the current flowing in the discharge lamp so that, when the polarity-inversion of the AC voltage starts, the current flowing in the coil is to be the first current value.

7. The lighting device of discharge lamp according to claim 5,
wherein the control circuit unit uses the first adjustment time based on the current flowing in the discharge lamp so that, when the ON/OFF control of the switching element starts after the generation of the second controlling signal, the current flowing in the coil is to be the second current value.

8. The lighting device of discharge lamp according to claim 1,
wherein the control circuit unit generates the first controlling signal to switch on the switching element, by adding or subtracting a second adjustment time based on the current flowing in the discharge lamp to or from a second period predetermined based on the current value flowing in the discharge lamp.

9. The lighting device of discharge lamp according to claim 8,
wherein the control circuit unit uses the second adjustment time base on the current flowing in the discharge lamp so that, when the ON/OFF control of the switching element restarts after the generation of the second controlling signal, the current flowing in the coil is to be the second current value.

10. The lighting device of discharge lamp according to claim 1,
wherein the polarity-inversion instructing signal is an external input signal input from the outside of a control unit or an internal generation signal generated in a control unit.

11. A method of controlling lighting of a discharge lamp by using a DC voltage generating circuit including: a switching element that is controlled by a first controlling signal, which is pulse width modulated in a current continuity mode, so that the switching element is controlled in ON/OFF; and a coil that has one end portion, to which a first DC voltage is input through the switching element, and the other end portion of the coil, the method comprising:
outputting a second DC voltage, into which the first DC voltage is converted based on a duty ratio of the first controlling signal;
converting the second DC voltage into an AC voltage and supplying the AC voltage to the discharge lamp;
receiving a polarity-inversion instructing signal that is asynchronous with the first controlling signal;
generating a second controlling signal to determine a timing of polarity-inversion after a predetermined first period is elapsed with reference to a reception timing of the polarity-inversion instructing signal;
setting a latest ON period of the switching element before the generation of the second controlling signal so that a current flowing in the coil when the polarity-inversion of the AC voltage starts is to be a first current value, wherein the latest ON period is set based on both an elapsed time from an ON timing of the switching element to the reception timing of the polarity-inversion instructing signal and the duty ratio of the first controlling signal in a normal state before the reception of the polarity-inversion instructing signal, and wherein the ON timing of the switching element is prior to or at the same time with the reception timing of the polarity-inversion instructing signal; and
generating the first controlling signal to restart the ON/OFF control of the switching element at a timing after a second period, which is predetermined based on the current value flowing in the discharge lamp, is elapsed from the generation of the second controlling signal so that, when the ON/OFF control of the switching element restarts after the generation of the second controlling signal, a current flowing in the coil is to be a second current value.
